(19) United States
(12) Patent Application Publication
(10) Pub. No.: US 2015/0015442 A1
(43) Pub. Date: Jan. 15, 2015

(54) SYSTEM AND METHOD TO FIND LOST OBJECTS

(71) Applicant: AKKA, INC., TACOMA, WA (US)

(72) Inventors: ANTHONY KOLB, TACOMA, WA (US); SCOTT THIELMAN, SEATTLE, WA (US); GEORGE NIEDERAUER, SEATTLE, WA (US); JUSTIN KNOWLES, SEATTLE, WA (US); DAVID CZARNECKI, SEATTLE, WA (US); GREGORY J. MARTIN, SEATTLE, WA (US)

(21) Appl. No.: 14/329,589

(22) Filed: Jul. 11, 2014

Related U.S. Application Data
(60) Provisional application No. 61/845,293, filed on Jul. 11, 2013.

(51) Int. Cl. G01S 1/08

(52) U.S. Cl. CPC G01S 1/08
USPC 342/450

(57) ABSTRACT

The invention disclosed herein is a system and method to locate lost objects. The system (1000) is comprised of at least one accessory, at least one computing device (e.g. smartphone, tablet, lap top), and at least one remote device. In one embodiment, the accessory computing device, and remote device may further comprise a compass, gyro, and/or accelerometer. In one embodiment the accessory and/or remote device may be embedded in sporting, outdoor, and working gear/tools.

### CROSS-REFERENCES TO RELATED APPLICATIONS

This application claims priority to U.S. Provisional Application 61/845,293, filed on Jul. 11, 2013, and incorporates said Provisional Application, in its entirety, by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF INVENTION

Every year, in the United States and Canada, an average of 100 people are either killed or injured by avalanches. Many of these individuals are backpackers, skiers, mountaineers, and workers who spend time in avalanche country. According to the French National Association for the Study of Snow and Avalanches (“ANENA”) the chances of a buried avalanche victim being found increases dramatically, if everyone in the group is carrying and using standard avalanche equipment. In 2010, the ANENA recommended that anyone in avalanche prone areas should carry beacons, probes, shovels, and a RECCO system (“RECCO”).

Both beacons and RECCOs are lacking Both systems are difficult to use. The RECCO receiver is bulky and expensive. The ANENA recommends that users practice frequently with these systems. Additionally, these beacons sense magnetic flux lines to determine location which do not necessarily point directly to a victim. Hence, novice users will be at a disadvantage. Both systems are limited because they have one type on antennae. The hand held receiver or detector may not be able to locate a victim who is using an older system, a different frequency, or a different name brand. A beacon may “look” for individuals who are not victims of the avalanche, causing precious time to be lost in the rescue process.

### BRIEF DESCRIPTION OF THE DRAWINGS

Other features and advantages of the present invention will become apparent in the following detailed descriptions of the preferred embodiment with reference to the accompanying drawings, of which:

FIG. 1 is a schematic showing the system and relevant antenna;

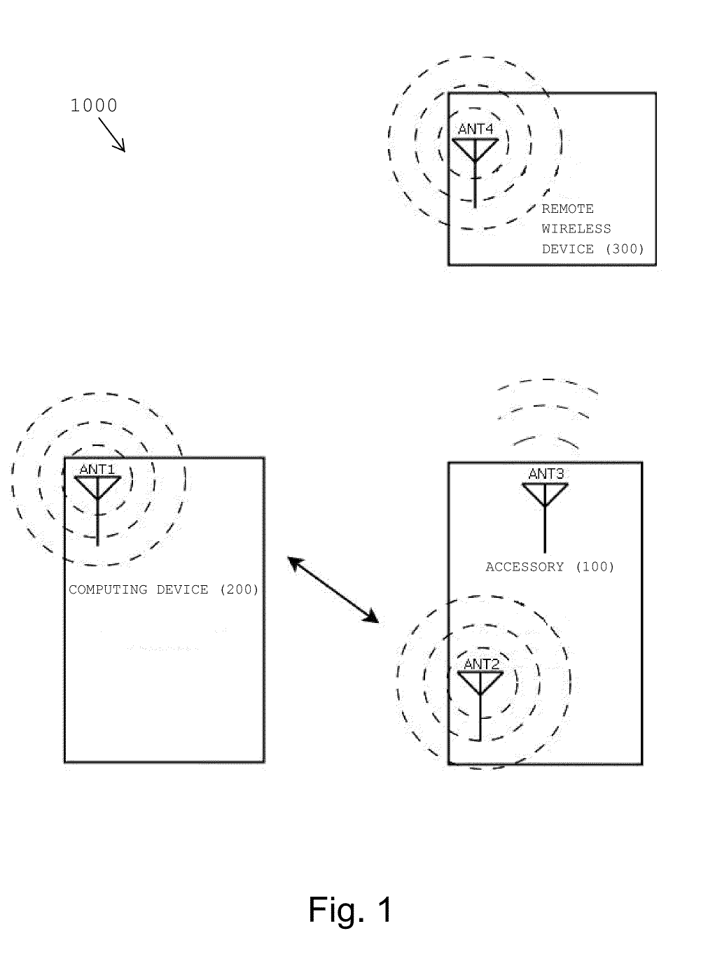

FIG. 2 is an exemplary hardware block diagram;

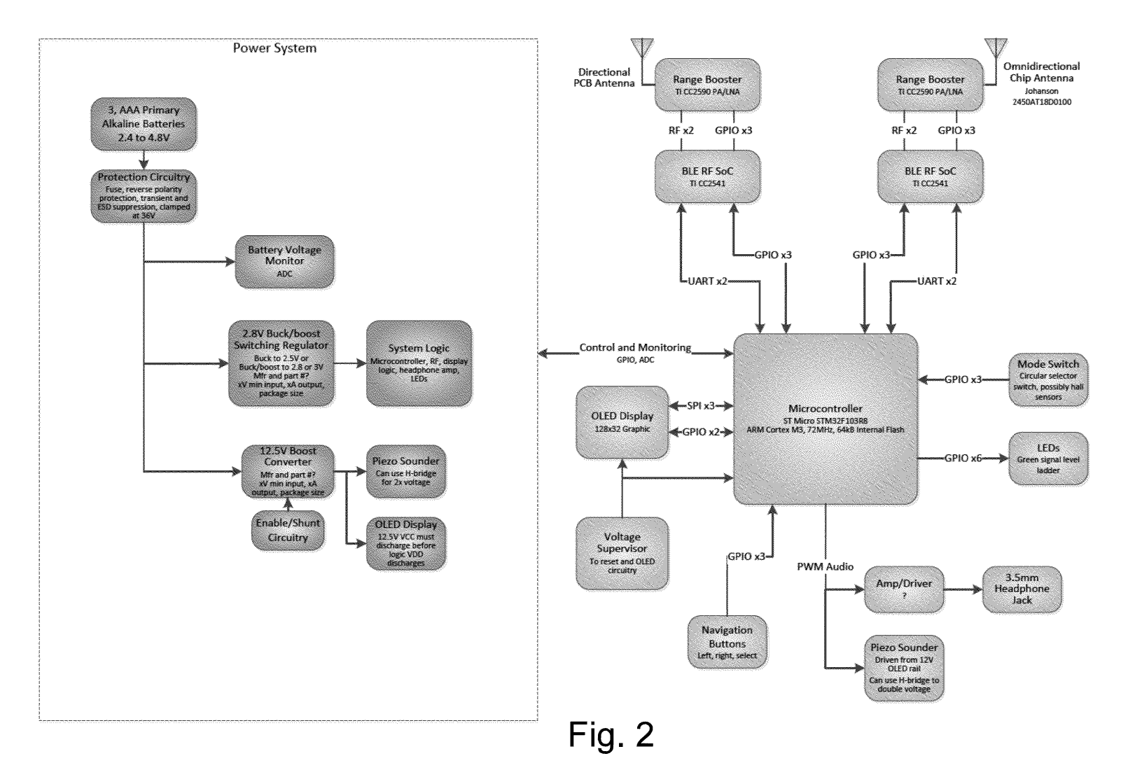

FIG. 3 is an exemplary hardware block diagram.

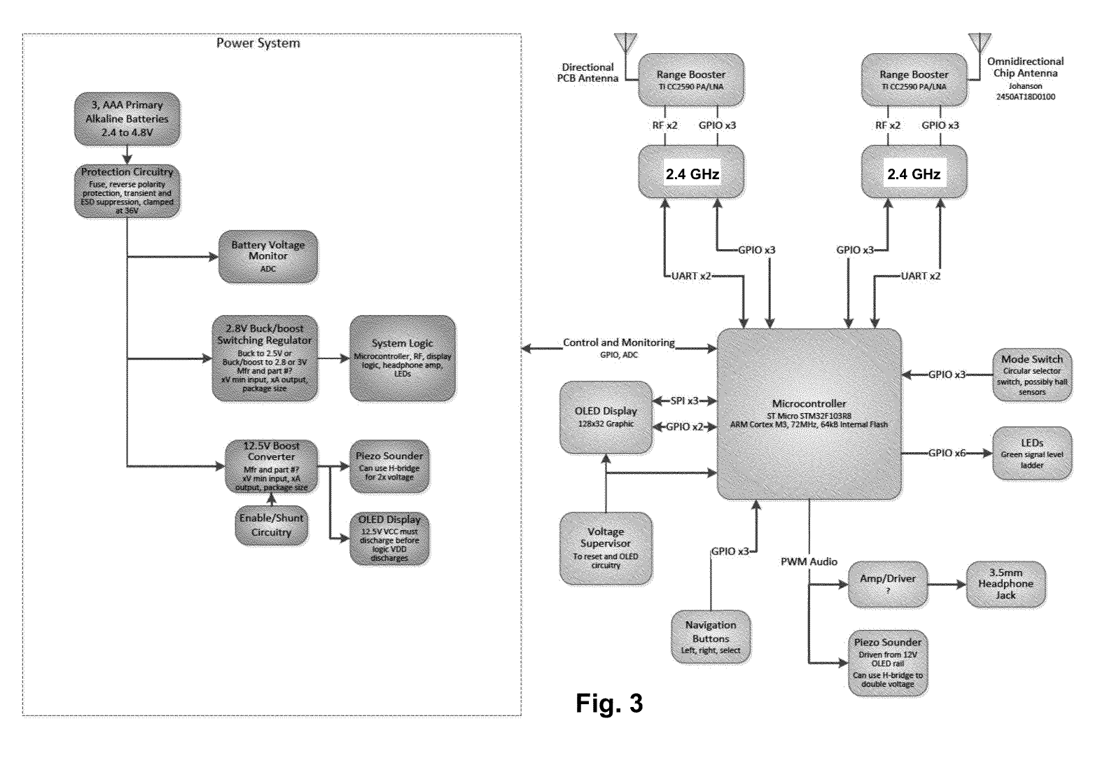

### DETAILED DESCRIPTION OF THE INVENTION

The invention disclosed herein is a system and method to locate lost objects. The system (1000) is comprised of at least one accessory (100), at least one computing device (200) (e.g. smartphone, tablet, lap top), and at least one remote device (300). In one embodiment, the accessory (100) computing device (200), and remote device (300) may further comprise a compass, gyro, and/or accelerometer. In one embodiment the accessory (100) and/or remote device (300) may be embedded in sporting, outdoor, and working gear/tools.

### 1. Accessory

The accessory (100) comprises at least an omni-directional antenna function (ANT2) and an intentionally directional antenna function (ANT3). In one embodiment, the omni-directional antenna function (ANT2) is for communicating with or signaling to at least one remote device (300) or another accessory (100) without regard to the relative orientation of the accessory (100) or remote device (300). The directional antennae function (ANT3) allows the accessory to communicate with at least one remote device (300) only when it is pointed to the remote device (300). The directional antennae function (ANT3) can be: a Yagi antenna, a patch antenna, a tube antenna, a log periodic antenna, a dish antenna, a phased array of antennas used to form a directional RF beam, any directional antenna with a dBi rating greater than 1, amongst others.

In one embodiment, the omni-directional antennae function (ANT2) is a chip antenna and the directional antenna function (ANT3) is a conductive trace antenna. In one embodiment, the omni-directional antennae function (ANT2) is a conductive trace antenna and the directional antenna function (ANT3) is a conductive trace antenna; where the trace form of omni-directional antenna function (ANT2) and directional antenna function (ANT3) have different forms. In one embodiment, at least one the directional antennae (ANT3) or the omni-directional antennae (ANT2) is a ceramic antennae.

In one embodiment, the information communicated to and from the accessory (100) is the intensity or strength of the incoming received signal. Received Signal Strength Indication (“RSSI”) is a common version of this information and can be used to determine direction and distance to radio beacons.

In one embodiment, the accessory (100) further comprises at least a: programmable computing device (e.g. a microcontroller); radio transceiver; radio frequency and/or a transmit/receive switch circuit which is controlled the programmable computing device. The programmable computing device can select between omni-directional antenna function (ANT2) and intentionally directional antenna function (ANT3).

In one embodiment, the accessory (100) further comprises: a programmable computing device (e.g. an apparatus having a microprocessor such as a lap top, smart phone, tablet), a radio transceiver for omni-directional antenna function (ANT2), a radio transceiver for intentionally directional antenna function (ANT3). The programmable computing device can select between the transceivers.

In one embodiment, the omni-directional antenna function (ANT2) is comprised of a programmable computing device (e.g. a microcontroller) and a radio transceiver; and the intentionally directional antenna function (ANT3) is comprised of a programmable device (e.g. a microcontroller) and a radio transceiver. In this embodiment, the programmable computing device would contain the ANT2 and ANT3 protocols for communication with the remote device (300).

In one embodiment, the ANT2 protocol and the ANT3 protocol are identical. In one embodiment, the ANT2 protocol and the ANT3 protocol are wireless personal area network (WPAN) protocol (e.g. WiFi, Bluetooth, Bluetooth 4.0, Bluetooth Low Energy, ZigBee, and IEEE802.15.4).

In one embodiment, the accessory (100) is configured to communicate the identity and signal strength of the remote device (300) to the computing device (200). The identity may be a unique alphanumeric identifier associated with the remote device (300), a name embedded into communications associated with the remote device (300), or a combination thereof. The accessory (100) may have a roster of identifiers where each identifier is associated with at least one remote device (300). The signal strength may be converted to an estimate of distance, and rapidly reported via the computing device (200) or the accessory (100) in the form of audio and visual feedback. This will aid the user in finding the orientation of peak RSSI.

In one embodiment, the accessory (100) has a display for characters or graphics used to communicate visually with the user (e.g. liquid crystal display); display to indicate RSSI, connection or battery level (e.g. lights); audio generator for creating a tone which may change in response to RSSI or indicate RSSI strength; switch for determining an identifier to search for at least one device (300).

### 2. Computing Device

The computing device (200) comprises antenna function (ANT 1). In one embodiment, the computing device (200) has a roster of identifiers where each identifier is associated with at least one remote device (300). In one embodiment, the roster of unique identifiers may be maintained on a remote server or the internet and shared with the computing device (200) through an interface such as a website.

### 3. The Remote Device

The at least one remote device (300) has a means to communicate (ANT4) with the at least one accessory (100), the at least one computing device (200), or a combination thereof. In one embodiment, the accessory (100) may be pointed or swept through a field of view to search for a remote device (300). Preferably, the means to communicate (ANT4) comprises an omni-directional antenna and an RF transmitter.

### 4. System Communications

The term communicating is used herein to refer to either radio transmission (an emission of electromagnetic energy of a certain frequency and modulation for encoding information) or radio reception (receipt and demodulation of information from ambient electromagnetic energy). The term may also encompass the combination of transmission and reception such that the devices are in conversation with one another. However, the term may also encompass any other known or unknown method allowing the accessory to communicate with another device. The term link is used herein to refer to a process in which a slave having Bluetooth protocol establishes a connection with a master having Bluetooth protocol. A slave can connect to only one master. Antennae may be chip antennae, trace antennae, ceramic antennae, or a combination thereof.

In one embodiment, both the omni-directional antenna and directional antenna communicate at 2.4 GHz. In one embodiment, the omni-directional and directional antenna communicate at 457 KHz. In one embodiment, the accessory (100) and remote wireless device (300) further comprise at least one 457 KHz antenna. Bluetooth or other similar protocols may be used so that the accessory (100), computing device (200), and/or remote device (300) can wirelessly communicate with each other. In one embodiment, the accessory (100) and the remote wireless device (300) have the ability to communicate at 2.4 GHz, 457 KHz, and with Bluetooth protocols.

In another embodiment, the accessory (100) and remote device (300) further comprises a

Global Positioning System (“GPS”). In this configuration, the accessory (100) and remote device (300) will use SPOT™ or other similar protocols to communicate location via the GPS and, the radio frequencies described above. In one embodiment, the accessory (100) and remote device (300) may use SPOT™ type protocols to communicate when other accessories (100) or remote devices (300) that are farther away while using radio frequency to communicate when other accessories (100) or remote devices (300) are closer. In one embodiment, the accessory (100) and remote device (300) may use SPOT™ type protocols and radio frequency to communicate at all ranges.

In one embodiment the accessory (100) omni-directional antenna (ANT2) communicates with a computing device (200). Once radio communication is established between the computing device (200) and the accessory (100), information passed from the accessory (100) to the remote device (300) may be processed and displayed to the computing device (200) and, information input from the computing device (200) may control features and behaviors of the remote device (300).

In one embodiment, the remote device (300) periodically transmits a generic advertising signal to communicate with the accessory (100). The advertisement signal may contain an identifier and may also be used to determine RSSI.

In one embodiment, both the device (300) and the accessory (100) communicate using the Low Energy protocol defined in Bluetooth version 4.0 and later versions. In this embodiment the radio associated with the intentionally directional function (ANT3) will typically, but not necessarily, be configured as a master and the radio associated with means to communicate (ANT4) will typically, but not necessarily, be configured as a slave.

Establishing a link between a master and slave (e.g., an accessory (100) to a device (300); or a computing device (200) to a remote device (300)) will limit the number of ways to search for a device (300). However, establishing a link may be beneficial in some circumstances. For example, the radio associated with directional antennae function (ANT3) may establish a link with the means to communicate (ANT4) in order to communicate information to the remote device (300). In another example, the radio associated with directional antennae function (ANT3) may establish a link with means to communicate (ANT4) in order to command the remote device (300) to broadcast more frequently. This may be particularly beneficial during a search effort.

In one embodiment, remote device (300) identifiers found in a field of view may be transmitted to a computing device (200) through the connection between antenna function (ANTI) and omni-directional antenna function (ANT2). The remote device (300) identifiers may be displayed on the computing device (200) and/or transferred to a remote server.

If there is more than one remote device (300) is in range of the directional antenna function (ANT3), the users of the computing device (200) or accessory (100) can select which remote device (300) the directional antenna (ANT3) should search. This may be done by filtering out certain identifiers. This may also be done by having the accessory (100) report all remote device (300) identifiers within view but establishes a link to a predetermined, or to be determined remote device (300).

In one embodiment, omni-directional antenna function (ANT2) can act as a remote device (300) such that the accessory (100) may be searched for by at least one other accessory (100). By way of example, a method of communication between two accessory (100) devices is described below.

### Exemplary Communications

Assume that Adam, Bob, Charlie, and Dan each hold an accessory (100) and have gone skiing. Adam, Bob, Charlie, and Dan have switched their accessory (100) to the “on” position prior to beginning their decent. In the “on” position the omni-directional antenna function (ANT2) broadcasts. Preferably, the omni-directional antenna function (ANT2) sends periodic advertisements.

Adam and Bob lead the group of four down the hill while Charlie and Dan follow a few hundred feet behind. John and Kyle, strangers to the group, begin their descent of the hill at the same time. During their descent an avalanche event occurs.

Adam and Bob do not know whether Charlie and Dan have been buried by the avalanche. Adam, Bob, Charlie, and Dan did not know that John and Kyle had started the descent at the same time they did.

John and Kyle may be carrying smart phones that continue to broadcast their locations via Bluetooth Low Energy advertising. Many applications used on smart phones request the user to broadcast their location using Low Energy Bluetooth technology. Most smart phone users do not close out the applications running on their smart phone or completely shut down their smartphone. John and Kyle may have a known beacon which communicates at 457 KHz.

Adam and Bob switch their accessory (100) to “search” which causes the intentionally directional function (ANT3) to search for Charlie and Dan's omni-directional antennae (ANT2). When Adam and Bob are in “search” mode, they will communicate to any other accessory (100), remote wireless device (300) and/or computing device (200) that they are “safe”.

Adam's accessory (100), now in “search mode”, discovers Charlie's omni-directional antennae (ANT2). Preferably, once Adam's accessory (100) discovers Charlie antennae (ANT2), Charlie's accessory (100) will be “tagged” showing that he has been found. Alternatively, or in concert, Adam's accessory (100) communicates to Bob's accessory (100) that it has found Charlie. Once “tagged”, the information will be communicated with any other accessory (100) searching, remote wireless device (300), computing device (200), or a combination thereof. This function notifies other searchers to stop searching for Charlie, and concentrate their efforts in finding other victims.

Adam, Bob, Charlie, and Dan may now continue their search for John and Kyle. John and Kyle may be found using the Low Energy Bluetooth communications packaged in their smart phone and/or by searching for their 457 KHz prior art beacon.

I claim as my invention:

1. A system to locate lost objects comprising at least one accessory, at least one computing system, at least one remote device, or a combination thereof

2. The system as set forth in claim 1 where the accessory is comprised of at least one omni-directional antenna function (ANT2) and at least one intentionally directional antenna function (ANT3).

3. The system as set forth in claim 2 where the at least one ANT2 and the at least one ANT3 operate concurrently in an “on” position.

4. The system as set forth in claim 2 where the at least one ANT2 and at least one ANT3 operate concurrently when the accessory is in a “search position”.

5. The system as set forth in claim 2 where the at least on ANT2 is turned off when the accessory is in a “search position”.

6. The system as set forth in claim 2 where ANT2 periodically advertises its position.

7. The system as set forth in claim 2 where the at least ANT2 and/or ANT3 communicate at 2.4 GHz and 457 KHz.

8. The system as set forth in claim 7 where the accessory is further comprised of a GPS.

9. The system as set forth in claim 8 where SPOT™ type protocols are used for communication.

10. The system as set forth in claim 2 where the accessory communicates incoming intensity/strength of received signal to another accessory, remote wireless device, computing device, or combination thereof

11. The system as set forth in claim 1 where the at least one computing device comprises at least one antenna function (ANT1).

12. The system as set forth in claim 11 where ANT1 is an omni-directional antenna, intentional directional antenna, or a combination thereof.

13. The system as set forth in claim 1 where the at least one remote device has a means to communicate with the at least one accessory, at least one computing device, or both.

15. The system as set forth in claim 13 where the means to communicate is an omni-directional antenna and a RF transmitter.

16. The apparatus as set forth in claim 15 where the omni-directional antenna and/or RF transmitter communicates at 2.4 GHz and 457 KHz.

17. The system as set forth in claim 16 where the remote device is further comprised of a GPS.

18. The system as set forth in claim 17 where SPOT™ type protocols are used for communication.
